(19) United States
(12) Patent Application Publication
(10) Pub. No.: US 2017/0142030 A1
(43) Pub. Date: May 18, 2017

(54) DIGITAL COAX NETWORK SPLITTER

(71) Applicant: ComplexIQ Inc., Braselton, GA (US)

(72) Inventors: Albert Lamar Garrett, Gadsden, AL (US); Jeffrey Scott Ford, Braselton, GA (US)

(21) Appl. No.: 15/221,117

(22) Filed: Jul. 27, 2016

Related U.S. Application Data
(60) Provisional application No. 62/254,261, filed on Nov. 12, 2015.

(51) Int. Cl. H04L 12/933; H04L 12/66; H04L 29/06

(52) U.S. Cl. CPC H04L 49/10; H04L 69/18; H04L 12/66

(57) ABSTRACT

Embodiments of the present invention are directed to a network bridge capable of terminating, translating, and adapting multiple networking technologies when replacing Analog Coax Network Splitters in a coaxial network, such as a Home Coaxial Network. One example embodiment comprises two or more Coax-Compatible Network Technology (CCNT) devices, a Network Switch, and optionally includes any combination of an Access Network Frequency Domain Multiplexer (ANFDM), Non-CCNT (NCCNT) device(s), and CCNT, NCCNT and/or Cable Access Network Ports. The Network Switch distributes network data among the CCNT/NCCNT devices present. Multiple embodied devices may connect by means of CCNT/NCCNT devices. If present, an ANFDM provides required frequency band distribution between the Coax Access Network Port and Coax Ports. CCNT and/or NCCNT devices serve as network Bridges, Gateways and/or Routers. Different CCNT and NCCNT devices may be of the same or different technology.

### CROSS-REFERENCE TO RELATED APPLICATION AND PRIORITY CLAIM

This application claims the benefit, under 35 U.S.C. §119(e), of United States Provisional Patent Application No. 62/254,261, filed 12 Nov. 2015, entitled “Digital Coax Network Splitter,” the entire contents and substance of which is incorporated herein by reference in its entirety as if fully set forth below.

### FIELD OF THE INVENTION

Embodiments of the present invention relate generally to transmission network systems, and, more particularly, to network splitters for use with coax transmission networks, such as a Home Coax Network, Building Coax Network, Customer Premise Coax Network, or the like.

### BACKGROUND

Cable, telco, and satellite operators deploying current technology devices distribute cable TV (CATV) and data networks within coax networks through Analog Coax Network Splitters (ACNSs). The use of ACNSs introduces power, bandwidth, coexistence, and interoperability issues for both existing and future generations of Coax Compatible Network Technology (CCNT) and the use of ACNSs is not compatible with Non-Coax Compatible Network Technology (NCCNT). New CCNT is required to be backward compatible on a shared medium created by the use of ACNSs, which thereby limits the performance capacity of the entire network. Rapid advances in transmission rates have outstripped the capacity of existing mesh or star shared-medium CCNTs. Use of ACNSs also imposes limitations on the scalability of CCNT devices. Utilizing a shared medium with ACNSs is therefore detrimental to desired goals of higher capacity, throughput, and lower power.

Embodiments of the present invention provide effective solutions to these problems and other issues created by ACNS usage by replacing one or more ACNS within a coax network.

### BRIEF SUMMARY

Embodiments of the present invention relate to the field of coax networks in single dwelling and multiple dwelling units (MDU), such as single family homes, apartments, offices, hospitals, shopping malls, etc., as well as other premises. For example, embodiments may be part of a Home Coax Network, a Building Coax Network, a Customer Premise Coax Network, and/or the like, generally referred to herein as a “Coax Network”. Embodiments of the present invention provide effective solutions to the problems created by Analog Coax Network Splitter (ACNS) usage by replacing one or more ACNS within a Coax Network with embodiments of the present invention. Embodiments of the present invention physically isolate the analog signal content at each Coax Port of the embodiment, thereby allowing cable, telco, and satellite operators to utilize backward compatible technology on an as-needed basis. When required, the embodiments may be configured to allow the passage of frequency spectrum onto each coaxial cable in a controlled manner such that only the desired frequency spectrum is exchanged between the embodiments and each connected customer premises equipment (CPE). The embodiments provide scalability of Coax Ports through interconnection among multiple present invention devices with Access Network Coax Ports, Coax Ports, and Network Ports. Embodiments may also provide scalability of Coax Ports through the use of commercial off-the-shelf ethernet routers/switches as a centralized interconnect for multiple present invention devices.

Briefly described, one embodiment provides a device comprising a network switch; two or more coax-compatible network technology devices; and two or more coax ports.

In some embodiments, the device may further comprise a coax access network port; and a corresponding coax-compatible network technology device. In some embodiments, the device functions as a coax-compatible network technology buffer and repeater. In some embodiments, the device functions as an N-port digital splitter.

In some embodiments, the device isolates multiple coaxial subnets to create multiple coax-compatible network technology networks, wherein the multiple coax-compatible network technologies may be the same or different network technologies. In some embodiments, the device bridges each coax-compatible network technology network to the network switch.

Another embodiment provides a system for a coax network comprising one or more digital coax network splitter devices; one or more coaxial subnets; and one or more customer premise equipment devices. The one or more digital coax network splitter devices of the system comprising a network switch; two or more coax-compatible network technology devices; and two or more coax ports.

In some embodiments, the one or more digital coax network splitter devices of the system may further comprise a coax access network port; and a corresponding coax-compatible network technology device. In some embodiments, the one or more digital coax network splitter devices of the system isolate each coaxial subnet to create multiple coax-compatible network technology networks, wherein the multiple coax-compatible network technologies may be the same or different network technologies. In some embodiments, one or more digital coax network splitter devices of the system bridge each coax-compatible network technology network to the network switch.

The foregoing summarizes only a few aspects of the embodiments of the present invention and is not intended to be reflective of the full scope of the present invention. Additional features and advantages of the present invention are set forth in the following detailed description and drawings, may be apparent from the detailed description and drawings, or may be learned by practicing the present invention. Moreover, both the foregoing summary and following detailed description are exemplary and explanatory and are intended to provide further explanation of the presently disclosed embodiments of the invention as claimed.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1 illustrates an example home coax network with the use of ACNS FIG. 2 illustrates an example coax network using a digital coax network splitter in place of ACNS, in accordance with some embodiments of the present invention.

FIG. 3 illustrates an exemplary embodiment of a digital coax network splitter, in accordance with some embodiments of the present invention.

FIG. 4 illustrates another exemplary embodiment of a digital coax network splitter which includes the embodiment illustrated in FIG. 3, in accordance with some embodiments of the present invention.

FIG. 5 illustrates another exemplary embodiment of a digital coax network splitter which includes an embodiment as illustrated in FIG. 3 or FIG. 4, in accordance with some embodiments of the present invention.

FIG. 6 illustrates another exemplary embodiment of a digital coax network splitter which includes embodiments as illustrated in FIG. 5, in accordance with some embodiments of the present invention.

FIG. 7 illustrates an exemplary embodiment of a digital coax network splitter for use in multiple dwelling unit premises, and which includes embodiments as illustrated in FIG. 5, in accordance with some embodiments of the present invention.

### DETAILED DESCRIPTION

Although preferred embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity. It should also be noted that, as used in the specification and the appended claims, the singular forms “a,” “an” and “the” include plural references unless the context clearly dictates otherwise. References to a composition containing “a” constituent is intended to include other constituents in addition to the one named.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is also to be understood that the mention of one or more method steps does not preclude the presence of additional method steps or intervening method steps between those steps expressly identified. Moreover, although the term “step” may be used herein to connote different aspects of methods employed, the term should not be interpreted as implying any particular order among or between various steps herein disclosed unless and except when the order of individual steps is explicitly required.

The components described hereinafter as making up various elements of the invention are intended to be illustrative and not restrictive. Many suitable components that would perform the same or similar functions as the components described herein are intended to be embraced within the scope of the invention. Such other components not described herein can include, but are not limited to, for example, similar components that are developed after development of the presently disclosed subject matter.

To facilitate an understanding of the principles and features of the invention, various illustrative embodiments are explained below. In particular, the presently disclosed subject matter may be described in the context of being used in a home coax network. The present invention, however, is not so limited, and can be applicable in other contexts. For example and not limitation, some embodiments of the present invention may improve other networking environments, such as a building coax network, a customer premise coax network, or the like. These embodiments are contemplated within the scope of the present invention. Accordingly, when the present invention is described in the context of a home coax network, it will be understood that other embodiments can take the place of those referred to.

The presently described embodiments relate to coax networks in single dwelling and multiple dwelling units (MDU), such as single family homes, apartments, offices, hospitals, shopping malls, etc., and other premises, for example, a coax network using MoCA-compliant technology, which provide networking over coax cable. Embodiments may provide effective solutions to the problems associated with Analog Coax Network Splitter (ACNS) usage by replacing one or more ACNS within a network, such as a home coax network (HCN), with embodiments of a digital coax network splitter as described herein. Embodiments may physically isolate the analog signal content at each Coax Port of a digital coax network splitter, thereby allowing cable, telco, satellite, or other network operators to utilize backward compatible technology on an as-needed basis. When required, embodiments may be configured to allow the passage of frequency spectrum onto each coaxial cable in a controlled manner such that only the desired frequency spectrum is exchanged between the embodiments and each connected customer premises equipment (CPE). The embodiments may provide scalability of Coax Ports through interconnection among multiple disclosed devices with Access Network Coax Ports, Coax Ports, and Network Ports. Embodiments may also provide scalability of Coax Ports through the use of commercial off-the-shelf ethernet routers and/or switches as a centralized interconnect for multiple disclosed devices. While MoCA technology is provided as one example type of network where embodiments of the disclosed digital coax network splitter may be implemented to provide network improvements, embodiments of the present invention are not limited to such, but may be implemented in data networks using a variety of networking technologies.

Implementing a coax network where at least a first ACNS is replaced by an embodiment of the disclosed digital coax network splitter provides a number of improvements, such as increased available network throughput and compatibility issue mitigation. In some embodiments, replacing additional ACNS downstream in the coax network (for example, replacing all ACNS within a coax network), with embodiments of the disclosed digital coax network splitter, may provide for increased improvements in the coax network.

Referring now to the figures, wherein like reference numerals represent like parts throughout the views, exemplary embodiments will be described in detail.

Embodiments of the present invention replace one or more ACNSs, allowing for terminating and physically isolating each CCNT network on each coaxial cable within a coax network.

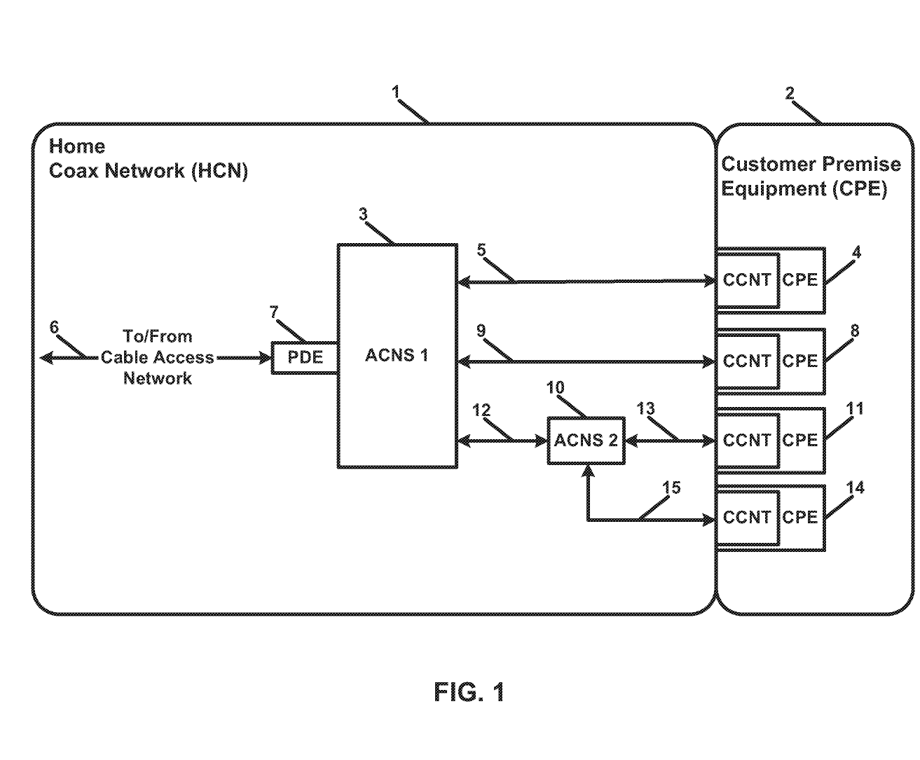

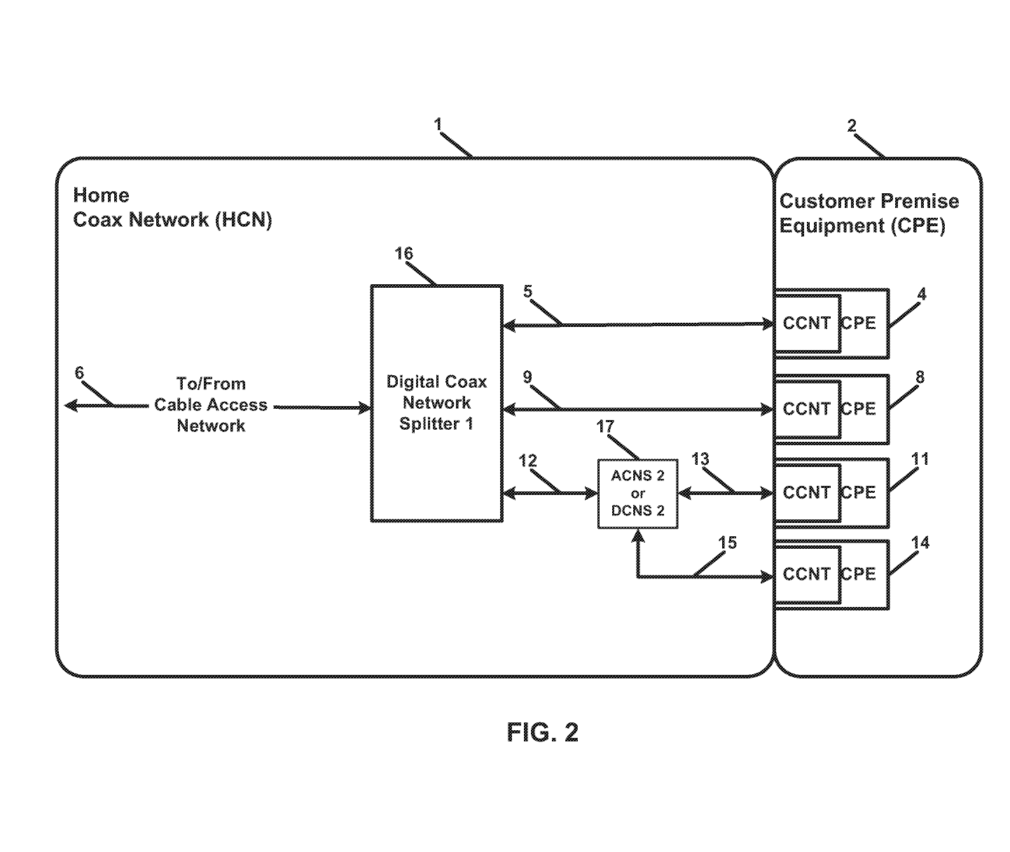

FIG. 1 illustrates an exemplary coax network using two ACNS for distribution of a cable access network and CCNT connections. In a typical HCN, such as HCN 1, the HCN 1 consists of a point-of-entry (POE) filter 7, an ACNS 3, and coaxial subnets. A coaxial subnet may be a single coaxial cable, such as each of coaxial cable 5 and coaxial cable 9, or a tree of coaxial cables and ACNS, such as coaxial cable 12, coaxial cable 13, coaxial cable 15, and ACNS 10. In either case, the consequence of using the ACNS in an HCN is that all customer premise equipment (CPE) devices 2, such as CPE 4, CPE 8, CPE 11, and CPE 14, form a single CCNT network and must coexist with the signal transmissions of the other CPE and any Access Signaling from the Access Network 6.

FIG. 2 illustrates an example coax network where a digital coax network splitter replaces at least a first ACNS, such as in HCN 1 illustrated in FIG. 1, in accordance with some embodiments of the present invention. Without any modification to the coaxial cable in the HCN 1 being necessary, the POE filter 7 and ACNS 3 are replaced with an embodiment of a digital coax network splitter, such as digital coax network splitter 16 (the functionality of the POE filter 7 is incorporated into the digital coax network splitter 16). Each additional ACNS in a coax network, such as ACNS 10, may also optionally be replaced with an embodiment of a digital coax network splitter, such as digital coax network splitter 17. The digital coax network splitter isolates each coaxial subnet to create multiple CCNT networks, and bridge each CCNT network to a common Network Switch.

By extension, in some embodiments, the Network Switch may be a digital signal processor which accepts digitized signals from the CCNT, combines the digitized signals from each CCNT with signal processing according to a combining function, and transmits that resulting (or portions thereof) signal spectrum to each CCNT for reconstruction and transmission. In this way, the Network Switch and its signal processing function determines which signals/spectrums pass to each CCNT, and preserve isolation and mitigate the analog signal loss inherent in an ACNS.

The embodiments of the digital coax network splitter inherently increase the aggregate available network throughput and mitigates the implications of backward compatibility within the coax network. For example, by isolating the coaxial subnets and creating multiple CCNT networks, the digital coax network splitter allows increased aggregate available network throughput by not limiting the network to comply with the capabilities of a particular CCNT. Additionally, utilization of a digital coax network splitter enables lower transmit power between devices. Further, utilization of a digital coax network splitter reduces the multipath environment enabling higher PHY rates between devices. Embodiments of the digital coax network splitter may provide support for a single networking technology or may support multiple different networking technologies within a coax network.

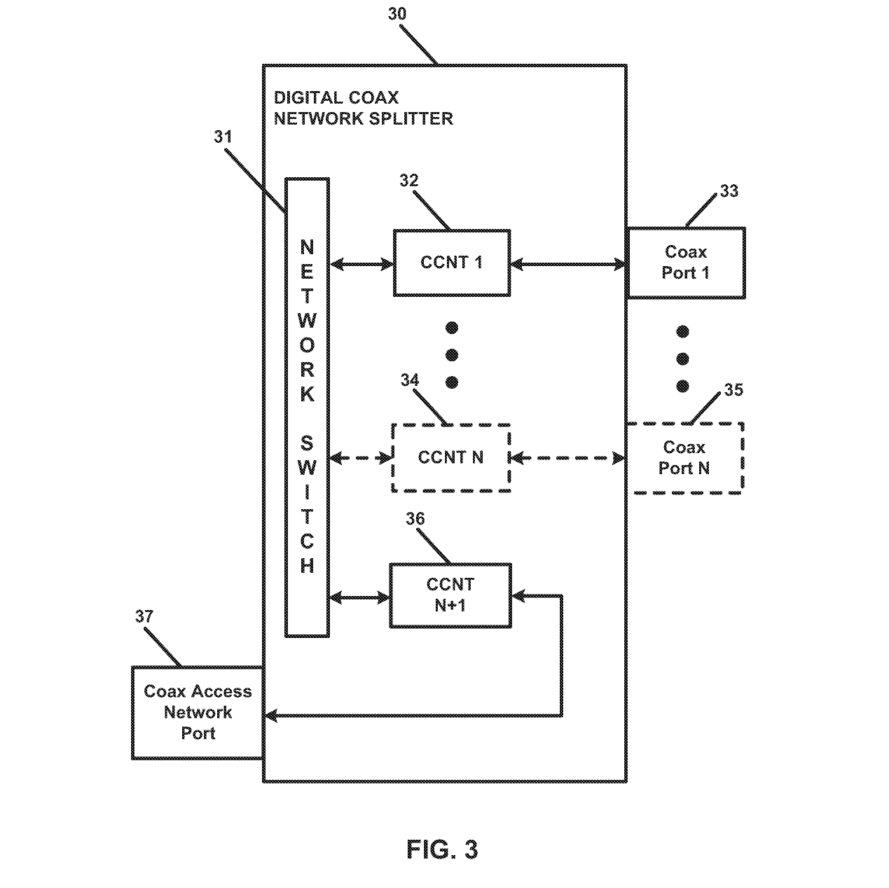

FIG. 3 illustrates a first exemplary embodiment of a digital coax network splitter, in accordance with some embodiments of the present invention. In the illustrated embodiment the digital coax network splitter 30 comprises a Network Switch 31, two or more CCNT devices, such as CCNT(1) 32, CCNT(N) 34, and CCNT(N+1) 36, one or more coax ports, such as Coax Port(1) 33 and Coax Port(N) 35, and optionally one Coax Access Network Port 37. The Network Switch 31 provides network connectivity between all the CCNT devices (CCNT(1) 32, CCNT(N) 34, and CCNT(N+1) 36) and the Coax Access Network. In various embodiments, the Network Switch 31 may be any network-interconnect technology, such as Ethernet Switch and/or TCP/IP router. When present, the Coax Access Network is connected through the Coax Access Network Port 37 and is bridged to the Network Switch 31 through one CCNT device, such as CCNT(N+1) 36. Each remaining CCNT device, for example, CCNT(1) 32 through CCNT(N) 34, physically isolates the Coaxial Subnet to which it connects and forms a separate CCNT network. The CCNT devices, CCNT(1) 32 through CCNT(N) 34, bridge each CCNT network to the interconnect technology of the Network Switch. In some embodiments where only two CCNT devices are comprised in the digital coax network splitter, the embodiment acts as a CCNT buffer/repeater. In some embodiments where a Coax Access Network port, a corresponding CCNT device, and N other CCNT devices (where N>1) are present, the embodiment may act as an N-port Digital Splitter.

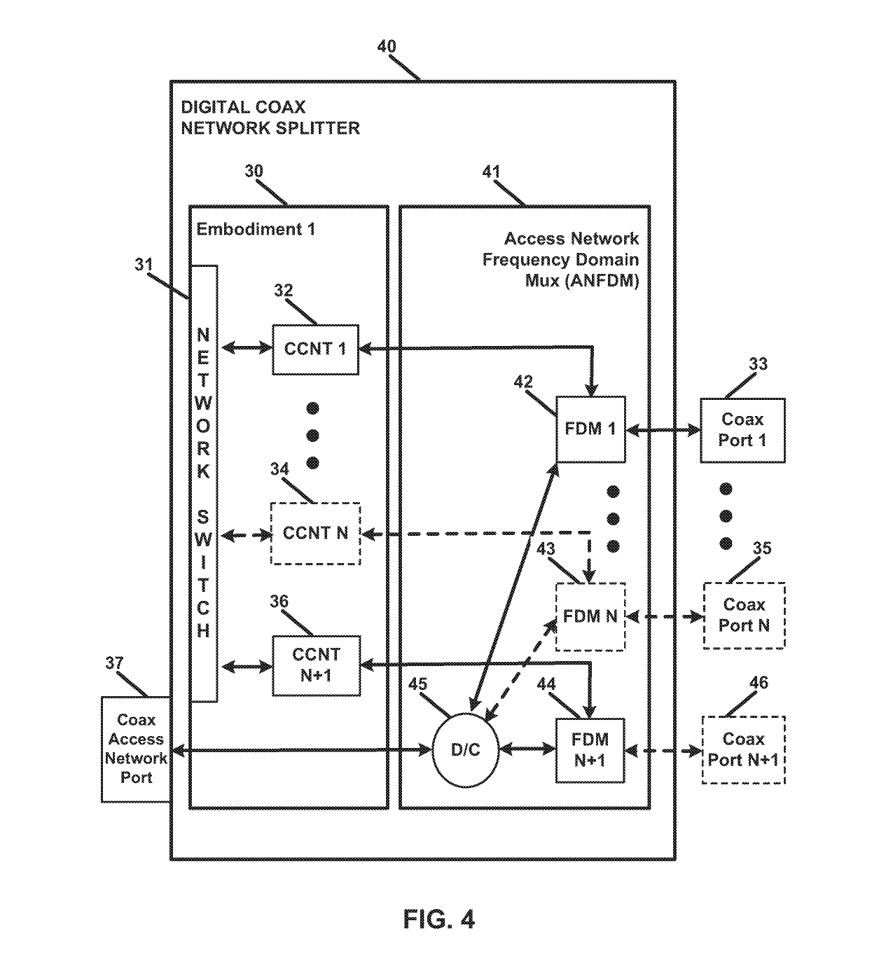

FIG. 4 illustrates a second exemplary embodiment of a digital coax network splitter, which includes the embodiment illustrated in FIG. 3, in accordance with some embodiments of the present invention. In some embodiments, a digital coax network splitter, such as digital coax network splitter 40, includes the digital coax network splitter 30, illustrated in FIG. 3, with the addition of an Access Network Frequency Domain Mux (ANFDM) 41. In embodiments such as illustrated in FIG. 4, the ANFDM 41 is inserted between the CCNT devices of the first embodiment illustrated in FIG. 3 (CCNT(1) 32 through CCNT(N) 34, and CCNT(N+1) 36) and their corresponding Coax Ports (Coax Port(1) 33 through Coax Port(N) 35, and Coax Port (N+1) 46). The ANFDM consists of a Distributor/Combiner (D/C) 45 having a connection to the Access Network Coax Port 37 and a plurality of Frequency Division Multiplexer (FDM) devices, such as FDM(1) 42 through FDM(N) 43, and FDM(N+1) 44, each of which has a connection to the D/C 45, a dedicated CCNT device (for example, one of CCNT(1) 32 through CCNT(N) 34, and CCNT(N+1) 36), and a dedicated Coax Port (for example, one of Coax Port(1) 33 through Coax Port(N) 35, and Coax Port(N+1) 46).

The D/C 45 at least performs a dual function of: a) distributing a portion or portions of the frequency spectrum from the Access Network to each FDM, FDM(1) 42 through FDM(N) 43, and FDM(N+1) 44, (which may include all or no frequencies); and b) combining a portion or portions of the frequency spectrum from each FDM, FDM(1) 42 through FDM(N) 43, and FDM(N+1) 44, and connecting the resultant frequency spectrum to the Coax Access Network Port 37 (which may include all or no frequencies). There is no requirement that the D/C 45 distributes and/or combines the same frequency spectrum portion(s) to/from each FDM (FDM(1) 42 through FDM(N) 43, and FDM(N+1) 44). If no frequencies are distributed or combined by the D/C 45, the Coax Access Network Port, the FDMs, and the D/C may be disabled, removed, or otherwise excluded from the embodiment.

As shown in FIG. 4, FDM(x) may perform frequency domain filtering, band selection, and merging between the D/C 45, CCNT(x), and Coax Port(x), where x is a value from 1 to N+1. In some embodiments, a portion or portions of the frequency spectrum from the D/C 45 may be merged with a portion or portions of the frequency spectrum of CCNT(x) (for example, one of CCNT 32, 34, or 36) by FDM(x) (for example, one of FDM 42, 43, or 44) and the resultant spectrum may be presented to Coax Port(x) (for example, one of Coax Port 33, 35, or 46). In some embodiments, a portion or portions of the frequency spectrum from Coax Port(x) (for example, one of Coax Port 33, 35, or 46) may be merged with a portion or portions of the frequency spectrum from the D/C 45 by FDM(x) (for example, one of FDM 42, 43, or 44) and the resultant spectrum may be presented to CCNT(x) (for example, one of CCNT 32, 34, or 36). In some embodiments, a portion or portions of the frequency spectrum from Coax Port(x) (for example, one of Coax Port 33, 35, or 46) may be merged with a portion or portions of the frequency spectrum from CCNT(x) (for example, one of CCNT 32, 34, or 36) by FDM(x) (for example, one of FDM 42, 43, or 44) and the resultant spectrum may be presented to the D/C 45. The phrase “a portion or portions of the frequency spectrum” can mean all or no frequencies. In some embodiments, if FDM(x) (for example, one of FDM 42, 43, or 44) is permanently configured to pass no portions of the CCNT frequency spectrum in either direction between CCNT(x) (for example, one of CCNT 32, 34, or 36) and Coax Port(x) (for example, one of Coax Port 33, 35, or 46), the CCNT(x) device and the FDM(x) device may be disabled, removed or otherwise excluded from the embodiment and a port of the D/C 45 may be connected directly to Coax Port(x).

Within this embodiment, the ANFDM 41 may at least provide the functions of, but is not limited to: a POE filter, an ACNS, one or more analog switches, and/or one or more analog diplexers, according to the ANFDM configuration. The ANFDM 41 may be implemented as any combination of passive analog, active analog, mixed-signal, and/or digital signal processor (DSP). One skilled in the art can define a configuration of this second exemplary embodiment to at least achieve the functionality of the first exemplary embodiment.

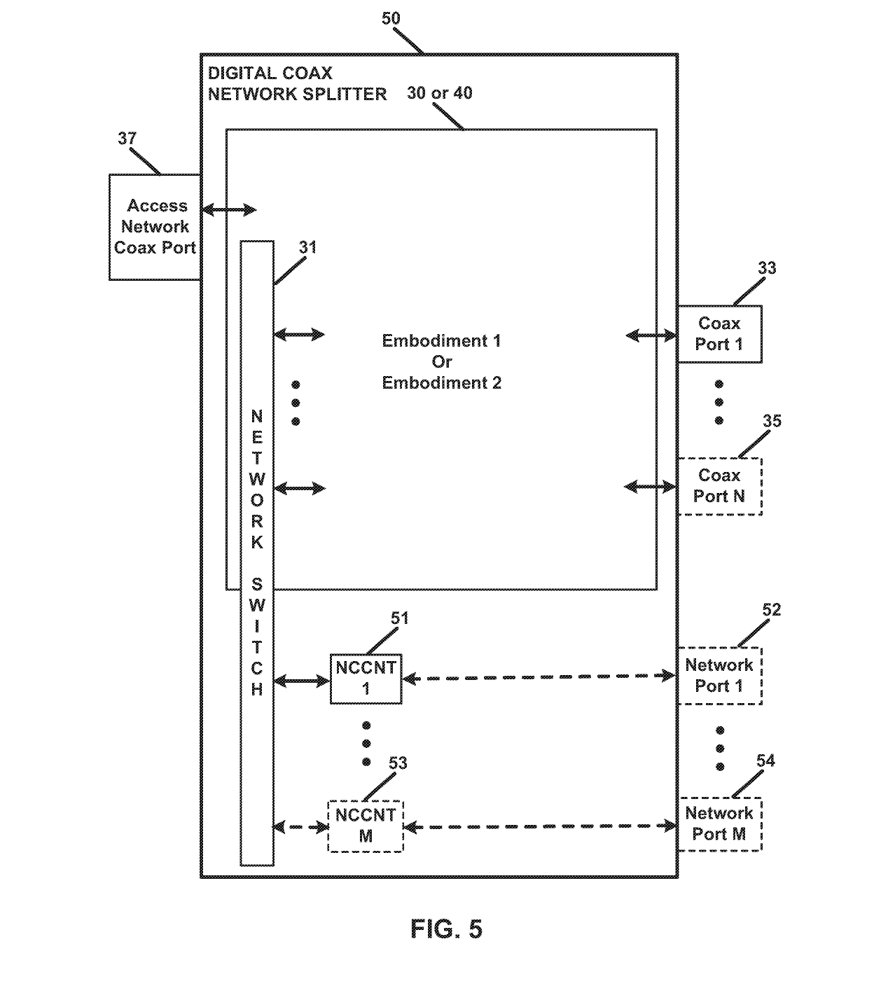

FIG. 5 illustrates another exemplary embodiment of a digital coax network splitter with the network switch extended to connect to a plurality of NCCNT devices, each of which optionally have corresponding network ports, in accordance with some embodiments of the present invention. In FIG. 5, a third embodiment of a digital coax network splitter, such as digital coax network splitter 50, is provided. The digital coax network splitter 50 includes the first embodiment 30 or second embodiment 40 of the digital coax network splitter with the Network Switch 31 additionally providing network connectivity to one or more NCCNT devices, such as NCCNT(1) 51 through NCCNT(M) 53, with each NCCNT device optionally connecting to a network port, such as Network Port(1) 52 through Network Port(M) 54. The NCCNT device (NCCNT(1) 51 through NCCNT(M) 53) forms a Network Bridge (which may be an Access Network Bridge) from any type of wired/wireless or optical network technology, such as, but not limited to, 1000Base-T Ethernet, 10GBase-T, fiber, or 802.11ac, to the network technology of the Network Switch 31. The combination of an NCCNT device, the Network Switch 31, and one or more CCNT devices may be used to generate/terminate Access Network Coax Signaling within the HCN. The NCCNT device may transmit/receive the Access Network data on a Network Port and bridge the data to/from the Network Switch 31. One or more CCNT devices may (re)generate/terminate Access Network Coax Signaling (e.g., DOCSIS (Data Over Cable Service Interface Specification) and/or Out-of-Band frequency spectrum) to/from the Network Switch 31.

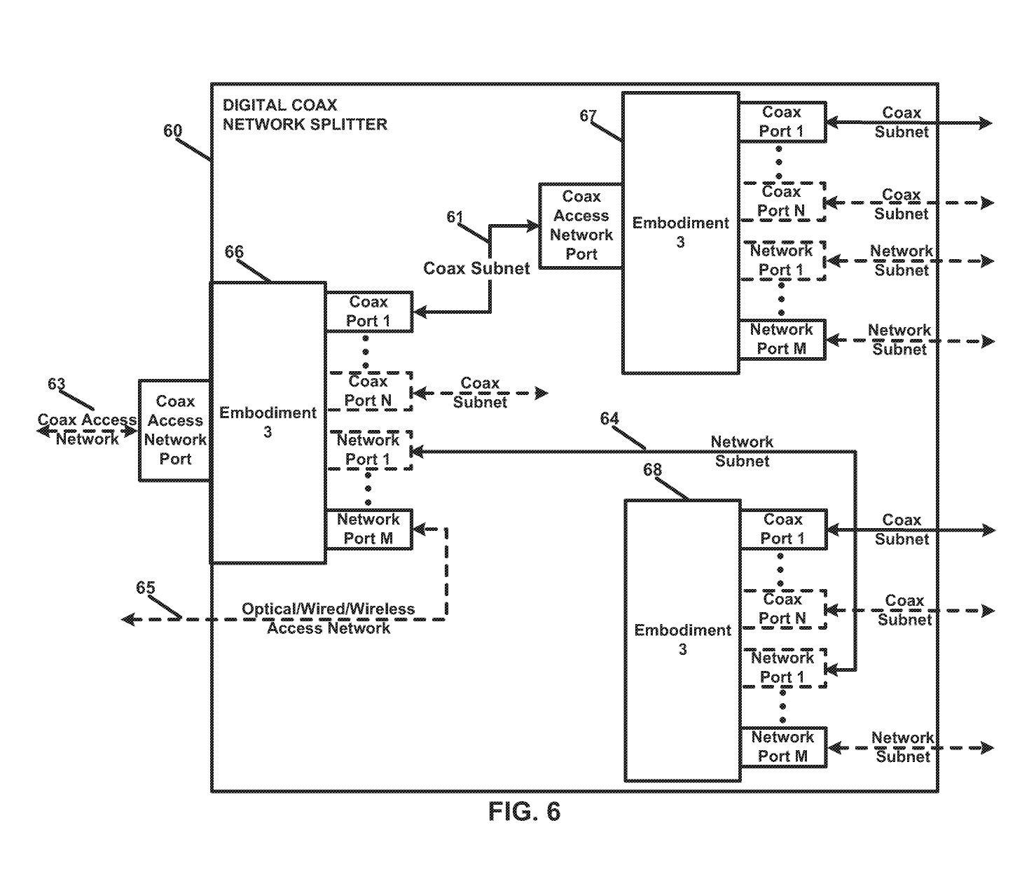

FIG. 6 illustrates a another exemplary embodiment of a digital coax network splitter comprising a plurality third embodiment digital coax network splitters, in accordance with some embodiments of the present invention. In FIG. 6, a fourth embodiment of a digital coax network splitter, such as digital coax network splitter 60, is provided. The digital coax network splitter 60 comprises a plurality of the third embodiment digital coax network splitter 50, as illustrated in FIG. 5, interconnected by Coax Subnets 61 and/or Network Subnets 64 to expand the total number of Coax Network Ports and/or Network Ports. In some embodiments, when one instance of the third embodiment digital coax network splitter 50, such as third embodiment digital coax network splitter 66, connects through one of its Coax Ports to the Coax Access Network Port of another instance of the third embodiment digital coax network splitter 50, such as third embodiment digital coax network splitter 67, the first instance 66 may provide Access Network signals to the second instance 67 through the ANFDM of the first instance 66. In some embodiments, the digital coax network splitter 60 may allow for two different Access Network connections may exist simultaneously, such as Coax Access Network 63 and Other Access Network 65 (for example, an Optical Access Network, Wired Access Network, and/or Wireless Access Network). In such embodiments, the digital coax network splitter 60 provides support for multiple networking technologies within the coax network, such as HCN 1.

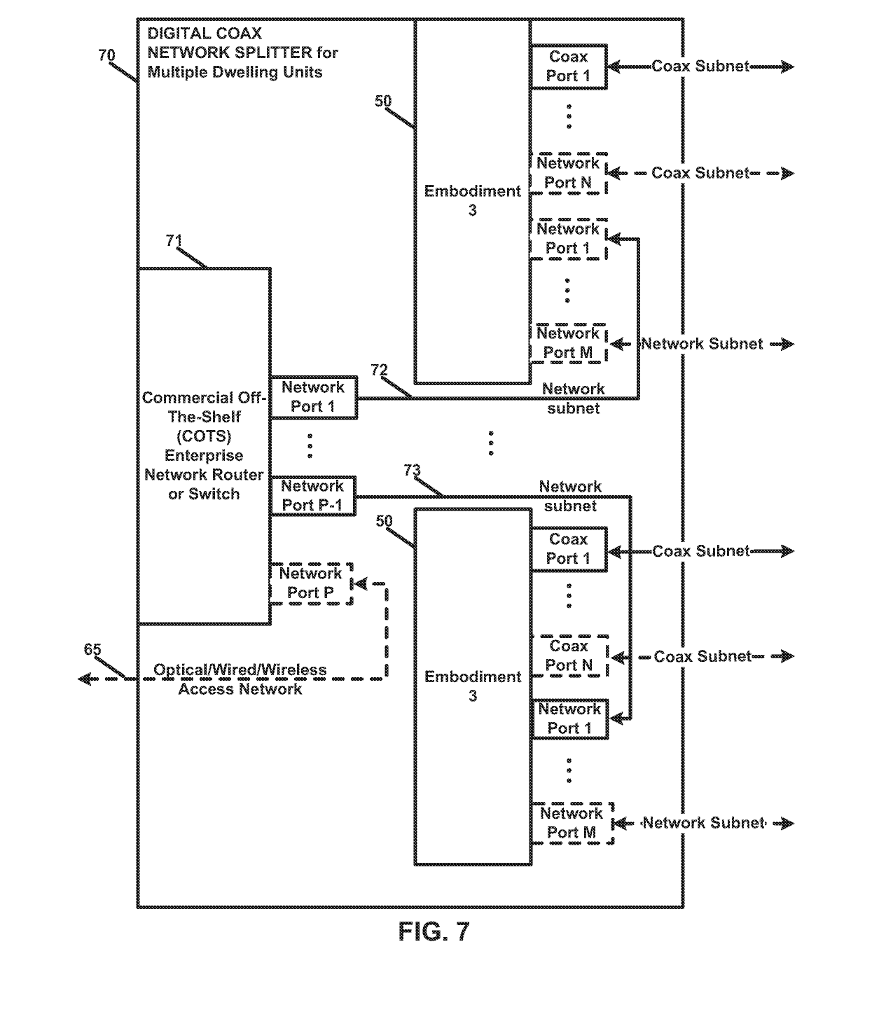

FIG. 7 illustrates an exemplary embodiment of a digital coax network splitter for use in multiple dwelling unit premises, in accordance with some embodiments of the present invention. In FIG. 7, a fifth embodiment of a digital coax network splitter, such as digital coax network splitter 70, is provided. The digital coax network splitter 70 comprises a plurality of the third embodiment digital coax network splitter 50, as illustrated in FIG. 5, interconnected by one or more Network Router(s)/Switch(es) 71 to allow for large scale expansion of the number of Coax Network Ports (e.g., for MDU services). In such embodiments, one port of the Network Router(s)/Switch(es) 71 is connected to a NCCNT device which bridges the Access Network (for example, 10GBaseT, fiber optic, wireless) 65. Each instance of the digital coax network splitter 50 connects to the Network Router/Switch 71 through a network port, such as through network port subnet 72 or network port subnet 73.

While the present disclosure has been described in connection with a plurality of exemplary aspects, as illustrated in the various figures and discussed above, it is understood that other similar aspects can be used or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

The included Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

Although various embodiments of the present invention have been shown and described, they are not meant to be limiting. Those of skill in the art may recognize certain modifications to these embodiments, which modifications are meant to be covered by the spirit and scope of the claims.

What is claimed is:

1. A device comprising:
a network switch;
two or more coax-compatible network technology devices; and
two or more coax ports.

2. The device of claim 1, further comprising
a coax access network port; and
a corresponding coax-compatible network technology device.

3. The device of claim 1, wherein the device functions as a coax-compatible network technology buffer and repeater.

4. The device of claim 2, wherein the device functions as an N-port digital splitter.

5. The device of claim 1, wherein the device isolates multiple coaxial subnets to create multiple coax-compatible network technology networks, wherein the multiple coax-compatible network technologies may be the same or different network technologies.

6. The device of claim 5, wherein the device bridges each coax-compatible network technology network to the network switch.

7. A system for a coax network, the system comprising:
one or more digital coax network splitter devices;
one or more coaxial subnets; and
one or more customer premise equipment devices;
the one or more digital coax network splitter devices comprising:
a network switch;
two or more coax-compatible network technology devices; and
two or more coax ports.

8. The system of claim 7, the one or more digital coax network splitter devices further comprising:
a coax access network port; and
a corresponding coax-compatible network technology device.

9. The system of claim 7, wherein the one or more digital coax network splitter devices isolate each coaxial subnet to create multiple coax-compatible network technology networks, wherein the multiple coax-compatible network technologies may be the same or different network technologies.

10. The system of claim 9, wherein the one or more digital coax network splitter devices bridge each coax-compatible network technology network to the network switch.
